(19) United States
(12) Patent Application Publication
(10) Pub. No.: US 2022/0335400 A1
(43) Pub. Date: Oct. 20, 2022

(54) PERFORMING PURCHASE TRANSACTIONS WITH AUDIO TRANSMISSIONS USING COMPLEX AUDIO SIGNALS

(71) Applicant: LISNR, Cincinnati, OH (US)

(72) Inventor: Srivathsan Narasimhan, Saratoga, CA (US)

(21) Appl. No.: 17/714,401

(22) Filed: Apr. 6, 2022

Related U.S. Application Data
(60) Provisional application No. 63/175,926, filed on Apr. 16, 2021.

(51) Int. Cl. G06Q 20/20; G10K 11/18

(52) U.S. Cl. CPC G06Q 20/202; G10K 11/18

(57) ABSTRACT

Methods and systems for performing purchase transactions with audio transmissions. In one embodiment, a method is presented that includes receiving, via a first communication interface, a first audio transmission containing purchase information for a transaction transmitted from a merchant device. The purchase information may be displayed and approval of the transaction from a user may be received. The transaction may be executed via a second communication interface responsive to receiving approval of the transaction from the user. A confirmation may be received via the second communication interface. An audio transmission containing the confirmation may be sent via the first communication interface, to the merchant device.

### PRIORITY CLAIM

The present application claims priority to and the benefit of U.S. Provisional Application 63/175,926, filed Apr. 16, 2021, the entirety of which is herein incorporated by reference.

### BACKGROUND

Data often needs to be transmitted between computing devices without connecting both devices to the same computing network. For example, in certain applications, a computing network may not exist near the computing devices, or it may be too cumbersome (e.g., may take too long) to connect one or both of the computing devices to a nearby computing network. Therefore, data may be transmitted directly from one computing device to another computing device.

### SUMMARY

The present disclosure presents new and innovative methods and systems for detecting and combining audio transmissions that contain data to perform purchase transactions with audio transmissions. In a first aspect, a system is provided that includes a processor and a memory. The memory may store instructions which, when executed by the processor, cause the processor to receive, via a first communication interface, a first audio transmission containing purchase information for a transaction transmitted from a merchant device. The memory may further store instructions which, when executed by the processor, cause the processor to display the purchase information and receive approval of the transaction from a user. The memory may store still further instructions, which when executed by a processor, cause the processor to execute, via a second communication interface, the transaction responsive to receiving approval of the transaction from a user. Additionally, the memory may store instructions, which when executed by the processor, cause the processor to receive a confirmation via the second communication interface and send, via the first communication interface, an audio transmission containing the confirmation to the merchant device.

In a second aspect according to the first aspect, the memory stores further instructions, which, when executed by the processor, cause the processor to locate the merchant device.

In a third aspect according to the first and second aspects, the merchant device is a point of sale (POS) device.

In a fourth aspect according to any of the first through third aspects, the purchase information includes at least one of a product identifier, a transaction identifier, a merchant identifier, and cost information.

In a fifth aspect according to any of the first through fourth aspects, the confirmation includes at least one of card validity information and card security information.

In a sixth aspect according to any of the first through fifth aspects, the confirmation includes at least one fund availability information and transaction approval information.

In a seventh aspect according to any of the first through sixth aspects, a mobile device includes the processor, and the mobile device is one of a mobile phone, a personal digital assistant (PDA), and a tablet.

In an eighth aspect according to any of the first through seventh aspects, at least one of the first and second audio transmissions occur in an ultrasonic frequency range.

In a ninth aspect according to the eighth aspect, the mobile device includes an ultrasonic transducer and an ultrasonic receiver, the ultrasonic transducer is configured to transmit digital data at frequencies above 20 kHz.

In a tenth aspect according to any of the eighth and ninth aspects, the merchant device includes an ultrasonic transducer and an ultrasonic receiver, the ultrasonic transducer is configured to transmit digital data at frequencies above 20 kHz.

In an eleventh aspect according to any of the first through tenth aspects, the transaction is a card-not-present transaction.

In a twelfth aspect, a method is provided that includes receiving, by a mobile device, via a first communication interface, a first audio transmission containing purchase information for a transaction transmitted from a merchant device. The method may also include displaying, by the mobile device, the purchase information. The method may further include receiving, by the mobile device, approval of the transaction from a user. Additionally, the method may include executing, by the mobile device, the transaction via a second communication interface responsive to receiving approval of the transaction from the user. The method may further include receiving, by the mobile device, a confirmation via the second communication interface. The method may still further include sending, by the mobile device, an audio transmission containing the confirmation, via the first communication interface, to the merchant device.

In a thirteenth aspect according to the twelfth aspect, the method further includes locating, by the mobile device, the merchant device.

In a fourteenth aspect according to the twelfth and thirteenth aspects, the merchant device is a point of sale (POS) device.

In a fifteenth aspect according to any of the twelfth through fourteenth aspects, the method further includes reviewing, by a user on the mobile device, the purchase information.

In a sixteenth aspect according to any of the twelfth through fifteenth aspects, the purchase information includes at least one of a product identifier, a transaction identifier, a merchant identifier, and cost information.

In a seventeenth aspect according to any of the twelfth through sixteenth aspects, the confirmation includes at least one of card validity information, card security information, fund availability information, and transaction approval information.

In an eighteenth aspect according to any of the twelfth through seventeenth aspects, at least one of the first and second audio transmissions occur in an ultrasonic frequency range.

In a nineteenth aspect according to the eighteenth aspect, at least one of the mobile device and the merchant device includes an ultrasonic transducer and an ultrasonic receiver, the ultrasonic transducer configured to transmit digital data at frequencies above 20 kHz.

In a twentieth aspect according to any of the twelfth through nineteenth aspects, the transaction is a card-not-present transaction.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the disclosed subject matter.

### BRIEF DESCRIPTION OF THE FIGURES

FIG. 1 illustrates a system according to an exemplary embodiment of the present disclosure.

FIG. 2 illustrates an audio transmission according to an exemplary embodiment of the present disclosure.

FIGS. 3A-3B illustrate transmitter/receiver array according to an exemplary embodiment of the present disclosure.

FIG. 4 illustrates a scenario according to an exemplary embodiment of the present disclosure.

FIG. 5 illustrates a transaction scenario according to an exemplary embodiment of the present disclosure.

FIG. 6 illustrates a transaction scenario according to an exemplary embodiment of the present disclosure.

FIGS. 7A-7B illustrate audio transmissions according to exemplary embodiments of the present disclosure.

FIG. 8 illustrates a method according to an exemplary embodiment of the present disclosure.

FIG. 9 illustrates a computing system according to an exemplary embodiment of the present disclosure.

### DETAILED DESCRIPTION OF EXAMPLE EMBODIMENTS

Aspects of the present disclosure relate to performing purchase transactions with audio transmissions. Further, various aspects relate using audio signals to transmit purchase information and payment transaction confirmations between computer devices such as merchant devices and customer devices (e.g., mobile devices).

Various techniques and systems exist to exchange data between computing devices without connecting to the same communication network. For example, the computing devices may transmit data via direct communication links between the devices. In particular, data may be transmitted according to one or more direct wireless communication protocols, such as Bluetooth®, ZigBee®, Z-Wave®, Radio-Frequency Identification (RFID), Near Field Communication (NFC), and Wi-Fi® (e.g., direct Wi-Fi links between the computing devices). However, each of these protocols relies on data transmission using electromagnetic waves at various frequencies. Therefore, in certain instances (e.g., ZigBee®, Z-Wave®, RFID, and NFC), computing devices may typically require specialized hardware to transmit data according to these wireless communication protocols. In further instances (e.g., Bluetooth®, ZigBee®, Z-Wave®, and Wi-Fi®), computing devices may typically have to be communicatively paired in order to transmit data according to these wireless communication protocols. Such communicative pairing can be cumbersome and slow, reducing the likelihood that users associated with one or both of the computing devices will utilize the protocols to transmit data.

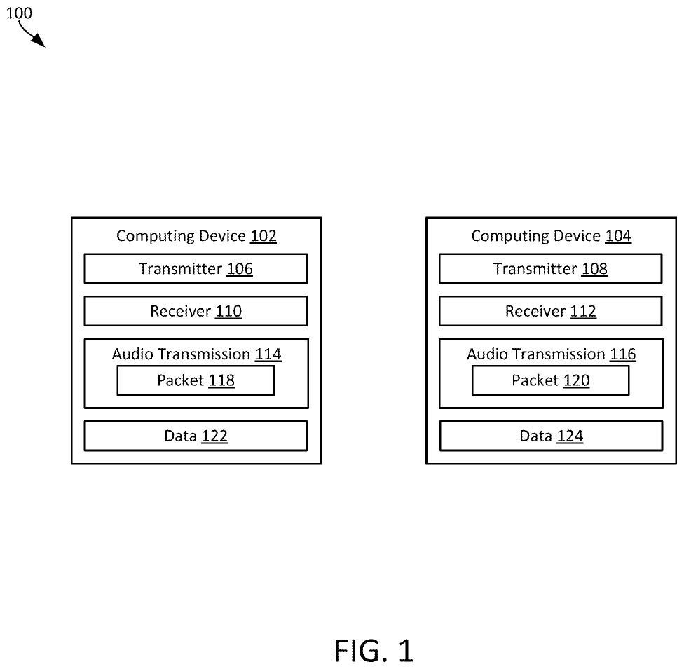

Therefore, there exists a need to wirelessly transmit data in a way that (i) does not require specialized hardware and (ii) does not require communicative pairing prior to data transmission and (iii) a system to exchange data reliably and securely. One solution to this problem is to transmit data using audio transmissions. For example, FIG. 1 illustrates a system 100 according to an exemplary embodiment of the present disclosure. The system 100 includes two computing devices 102, 104 configured to transmit data 122, 124 using audio transmissions 114, 116. In particular, each computing device 102, 104 includes a transmitter 106, 108 and a receiver 110, 112. The transmitters 106, 108 or transducers may include any type of device capable of generating audio signals, such as speakers. In certain implementations, the transmitters 106, 108 or transducers may be implemented as a speaker built into the computing device 102, 104. For example, one or both of the computing devices may be a smart phone, tablet computer, and/or laptop with a built-in speaker that performs the functions of the transmitter 106, 108. In other implementations, the transmitters 106, 108 or transducers may be implemented as a microphone external to the computing device 102, 104. For example, the transmitters 106, 108 may be implemented as one or more speakers externally connected to the computing device 102, 104. In other implementations, the transmitters 106, 108 or transducers may be ultrasonic transducers configured to transmit digital data in an ultrasonic frequency range. For example, the ultrasonic transducer may transmit digital data at frequencies above 20 kHz (e.g., 20-100 kHz).

The receivers 110, 112 may include any type of device capable of receiving audio transmissions and converting the audio transmissions into signals (e.g., digital signals) capable of being processed by a processor of the computing device, such as microphones. In other implementations, the receivers 110, 112 may be implemented as a microphone built into the computing device 102, 104. For example, one or both of the computing devices may be a smartphone, tablet computer, and/or laptop with a built-in microphone that performs the functions of the receivers 110, 112. In other implementations, the receivers 110, 112 may be implemented as a microphone external to the computing device 102, 104. For example, the receivers 110, 112 may be implemented as one or more microphones external to the computing device 102, 104 that are communicatively coupled to the computing device 102, 104. In other implementations, the receivers 110, 112 may be ultrasonic receiver configured to receive and convert digital data in an ultrasonic frequency range. For example, the ultrasonic receiver may receive and convert digital data at frequencies above 20 kHz (e.g., 20-100 kHz). In certain implementations, the transmitter 106, 108 and receiver 110, 112 may be implemented as a single device connected to the computing device. For example, the transmitter 106, 108 and receiver 110, 112 may be implemented as a single device containing at least one speaker and at least one microphone that is communicatively coupled to the computing device 102, 104.

In certain implementations, one or both of the computing devices 102, 104 may include multiple transmitters 106, 108 and/or multiple receivers 110, 112. For example, the computing device 104 may include multiple transmitters 108 and multiple receivers 112 arranged in multiple locations so that the computing device 104 can communicate with the computing device 102 in multiple locations (e.g., when the computing device 102 is located near at least one of the multiple transmitters 108 and multiple receivers 112. In additional or alternative implementations, one or both of the computing devices 102, 104 may include multiple transmitters 106, 108 and/or multiple receivers 110, 112 in a single location. For example, the computing device 104 may include multiple transmitters 108 and multiple receivers 112 located at a single location. The multiple transmitters 108 and multiple receivers 112 may be arranged to improve coverage and/or signal quality in an area near the single location. For example, the multiple transmitters 108 and multiple receivers 112 may be arranged in an array or other configuration so that other computing devices 102 receive audio transmissions 114, 116 of similar quality regardless of their location relative to the transmitters 108 and receivers 112 (e.g., regardless of the location of the computing devices 102 within a service area of the transmitters 108 and receivers 112).

The computing devices 102, 104 may generate audio transmissions 114, 116 to transmit data 122, 124 to one another. For example, the computing devices 102 may generate one or more audio transmissions 114 to transmit data 122 from the computing device 102 to the computing device 104. As another example, the computing device 104 may generate one or more audio transmissions 116 to transmit data 124 from the computing device 104 to the computing device 102. In particular, the computing devices 102, 104 may create one or more packets 118, 120 based on the data 122, 124 (e.g., including a portion of the data 122, 124) for transmission using the audio transmissions 114, 116. To generate the audio transmission 114, 116, the computing devices 102, 104 may modulate the packets 118, 120 onto an audio carrier signal. The computing devices 102, 104 may then transmit the audio transmission 114, 116 via the transmitter 106, 108, which may then be received by the receiver 110, 112 of the other computing devices 102, 104. In certain instances (e.g., where the data 122, 124 exceeds a predetermined threshold for the size of a packet 118, 120), the data 122, 124 may be divided into multiple packets 118, 120 for transmission using separate audio transmissions 114, 116.

Accordingly, by generating and transmitting audio transmissions 114, 116 in this way, the computing devices 102, 104 may be able to transmit data 122, 124 to one another without having to communicatively pair the computing devices 102, 104. Rather, a computing device 102, 104 can listen for audio transmissions 114, 116 received via the receivers 110, 112 from another computing device 102, 104 without having to communicatively pair with the other computing device 102, 104. Also, because these techniques can utilize conventional computer hardware like speakers and microphones, the computing devices 102, 104 do not require specialized hardware to transmit the data 122, 124.

Data may be transferred between devices during a commercial purchase transaction. For example, transactions may occur to purchase products or services in person (e.g., when the customer is present with their credit card) or remotely (e.g., when a customer conducts an online transaction and both the customer and credit card are not present). A “card-present” transaction may include chip and PIN payments, contactless/NFC payments, swipe and signature payments, mobile wallet payments through contactless/NFC. Conversely, a “card-not-present” transaction occurs when a credit card is not physically present at the time of the transaction. For example, a merchant is unable to physically view the credit or debit card to complete the transaction. A card-not-present transaction may also occur when both a cardholder and the credit card or debit card are not physically present at the time of the transaction. For example, some typical card-not-present transaction examples include over-the-phone and mail order payments, online shopping, manual card entry in payment apps, recurring or subscription billing, and mobile wallet payments.

Card-not-present transactions are becoming increasingly popular as more products and services are offered via digital commerce platforms. However, the level for risk for a merchant is typically higher for card-not-present transactions because the merchant is unable to verify the transaction personally (e.g., by comparing a credit card to a driver's license, comparing signature at checkout, etc.). Also, card-not-present transactions may become cumbersome and slow waiting for communicative pairing between devices as well as the increased bandwidth and load on conventional communication interfaces. Furthermore, card-not present transactions that are made in person may require devices to be located physically near one another (e.g., to facilitate the use of proximity-based communication protocols such as QR-Code or bar-code reader based payments).

Therefore, there exists a need to account for the security risks and network load of card-not-present transactions. One solution to this problem is to transmit purchase information and payment transaction confirmations as secure audio transmissions via an audio interface, which may increase both the security of the transaction and reduce bandwidth on conventional communication interfaces such as network communication interfaces. Audio transmissions may provide additional security due to the proximity required between the transmitting and receiving device, while also enabling users to perform such transactions without having to be next to merchant devices, as may be required for NFC or similar protocols. Information may be wirelessly transmitted information using audio transmissions without specialized hardware (e.g., using existing speakers and microphones on the devices) and without communicatively pairing the devices prior to the transaction.

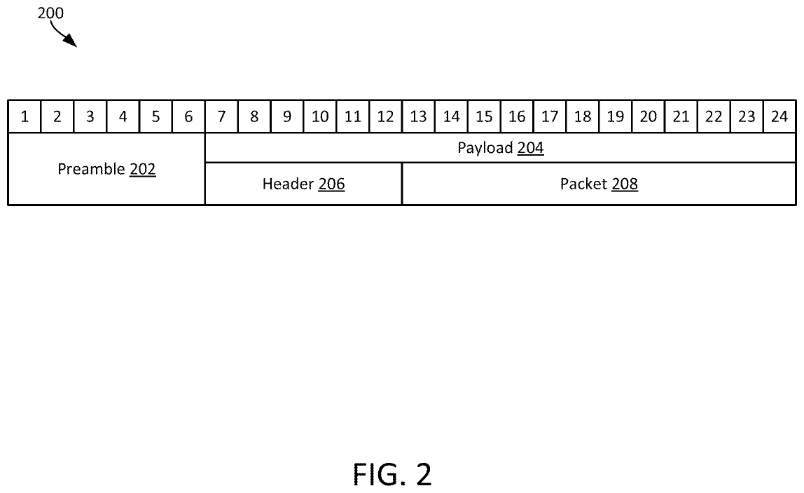

FIG. 2 illustrates an audio transmission 200 according to an exemplary embodiment of the present disclosure. The audio transmission 200 may be used to transmit data from one computing device to another computing device. For example, referring to FIG. 1, the audio transmission 200 may be an example implementation of the audio transmissions 114, 116 generated by the computing devices 102, 104. The audio transmission 200 includes multiple symbols 1-24, which may correspond to discrete time periods within the audio transmission 200. For example, each symbol 1-24 may correspond to 2 ms of the audio transmission 200. In other examples, the symbols 1-24 may correspond to other time periods within the audio transmission 200 (e.g., 1 ms, 10 ms, 20 ms, 40 ms). Each symbol 1-24 may include one or more frequencies used to encode information within the audio transmission 200. For example, the one or more frequencies may be modulated in order to encode information in the audio transmission 200 (e.g., certain frequencies may correspond to certain pieces of information). In another example, the phases of the frequencies may additionally or alternatively be modulated in order to encode information in the audio transmission 200 (e.g., certain phase differences from a reference signal may correspond to certain pieces of information).

In particular, certain symbols 1-24 may correspond to particular types of information within the audio transmission 200. For example, the symbols 1-6 may correspond to a preamble 202 and symbols 7-24 may correspond to a payload 204. The preamble 202 may contain predetermined frequencies produced at predetermined points of time (e.g., according to a frequency pattern). In certain implementations, the preamble 202 may additionally or alternatively contain frequencies (e.g., a particular predetermined frequency) whose phase differences are altered by predetermined amounts at predetermined points of time (e.g., according to a phase difference pattern). The preamble 202 may be used to identify the audio transmission 200 to a computing device receiving the audio transmission 200. For example, a receiver of the computing device receiving audio transmissions such as the audio transmission 200 may also receive other types of audio data (e.g., audio data from environmental noises and/or audio interference). The preamble 202 may therefore be configured to identify audio data corresponding to the audio transmission 200 when received by the receiver of the computing device. In particular, the computing device may be configured to analyze incoming audio data from the receiver and to disregard audio data that does not include the preamble 202. Upon detecting the preamble 202, the computing device may begin receiving and processing the audio transmission 200. The preamble may also be used to align processing of the audio transmission 200 with the symbols 1-24 of the audio transmission 200. In particular, by indicating the beginning of the audio transmission 200, the preamble 202 may enable the computing device receiving the audio transmission 200 to properly align its processing of the audio transmission with the symbols 1-24.

The payload 204 may include the data intended for transmission, along with other information enabling proper processing of the data intended for transmission. In particular, the packets 208 may contain data desired for transmission by the computing device generating the audio transmission 200. For example, and referring to FIG. 1, the packet 208 may correspond to the packets 118, 120 which may contain all or part of the data 122, 124. The header 206 may include additional information for relevant processing of data contained within the packet 208. For example, the header 206 may include routing information for a final destination of the data (e.g., a server external to the computing device receiving the audio transmission 200). The header 206 may also indicate an originating source of the data (e.g., an identifier of the computing device transmitting the audio transmission 200 and/or a user associated with the computing device transmitting the audio transmission 200).

The preamble 202 and the payload 204 may be modulated to form the audio transmission 200 using similar encoding strategies (e.g., similar encoding frequencies and/or phase differences). Accordingly, the preamble 202 and the payload 204 may be susceptible to similar types of interference (e.g., similar types of frequency-dependent attenuation and/or similar types of frequency-dependent delays). Proper extraction of the payload 204 from the audio transmission 200 may rely on proper demodulation of the payload 204 from an audio carrier signal. Therefore, to accurately receive the payload 204, the computing device receiving the audio transmission 200 must account for the interference.

Symbols 1-24 and their configuration depicted in FIG. 2 are merely exemplary. It should be understood that certain implementations of the audio transmission 200 may use more or fewer symbols, and that one or more of the preamble 202, the payload 204, the header 206, and/or the packet 208 may use more or fewer symbols than those depicted and may be arranged in a different order or configuration within the audio transmission 200.

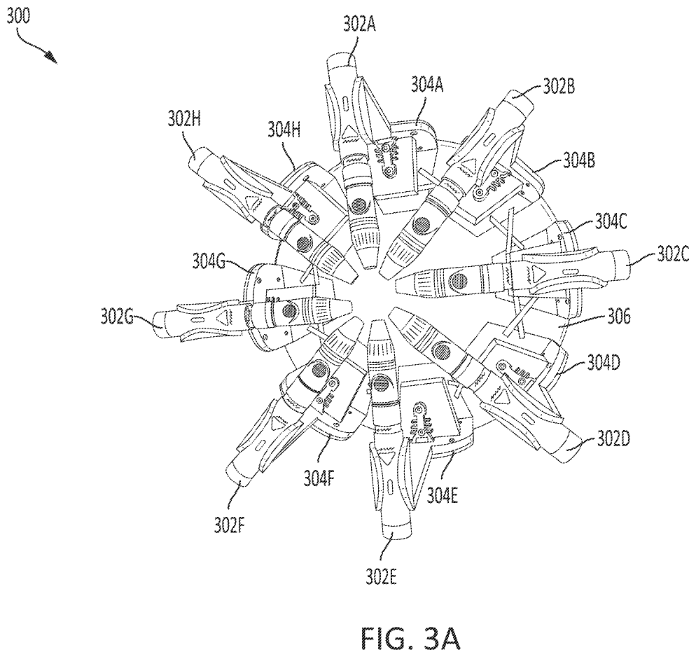

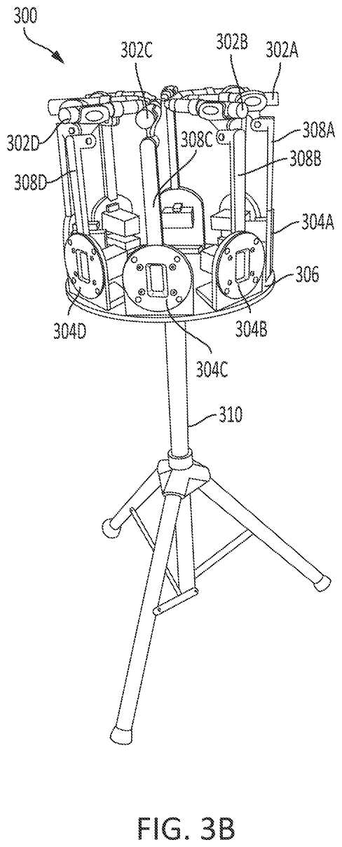

FIGS. 3A-3B illustrate a transmitter/receiver array 300 according to an exemplary embodiment of the present disclosure. The transmitter/receiver array 300 may be used to transmit and/or receive audio transmission 200. For example, the transmitter/receiver array 300 may be an exemplary implementation of at least one of the computing devices 102, 104. The transmitter/receiver array 300 includes eight receivers 302A-H and eight transmitters 304 A-H. Each of the eight receivers 302A-H may be exemplary implementations of the receivers 110, 112. For example, the eight receivers 302A-H may be implemented as microphones. Each of the eight transmitters 304A-H may be exemplary implementations of the transmitters 106, 108. For example, the eight transmitters 304A-H may be implemented as speakers.

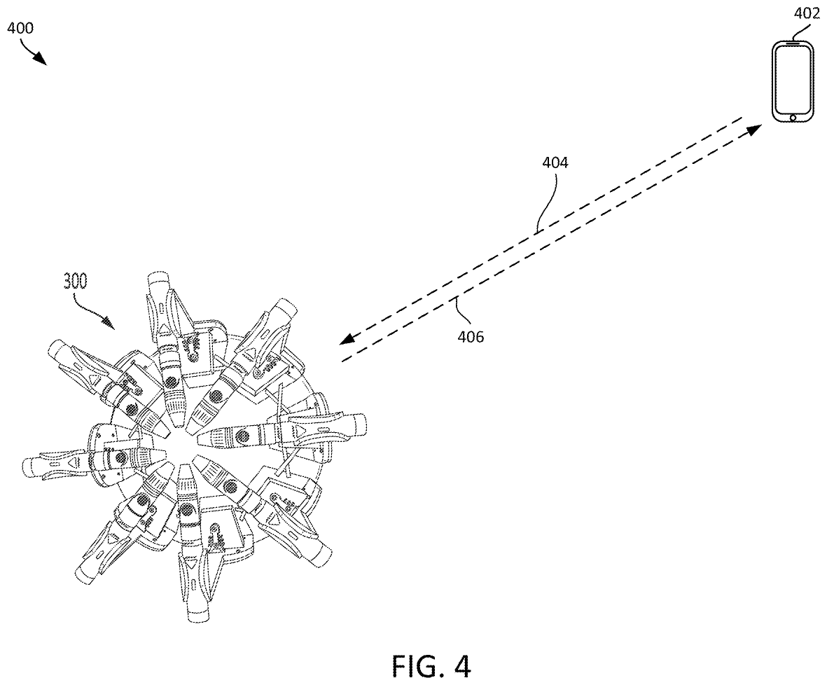

As depicted, the receivers 302A-H and the transmitters 304A-H are arranged to evenly cover a 360° area surrounding the transmitter/receiver array 300. For example, the receivers 302A-H and transmitters 304A-H are arranged so that there is approximately 45° between adjacent receivers 302A-H and adjacent transmitters 304A-H. Such a configuration may enable the transmitter/receiver array 300 to receive audio transmissions 200 from and transmit audio transmissions 200 in multiple directions within a coverage area of the transmitter/receiver array 300. The transmitter/receiver array 300 may be configured to receive and transmit audio transmissions from computing devices located within the coverage area of the transmitter/receiver array 300. For example, FIG. 4 illustrates a scenario 400 in which a computing device 402 (e.g., a mobile device) transmits audio transmissions 404 to the transmitter/receiver array 300 and receives audio transmissions 406 from the transmitter/receiver array 300.

Returning to FIGS. 3A-3B, the receivers 302A-H and the transmitters 304A-H may be mounted on a support body 306. The support body 306 may allow the transmitter/receiver array 300 to be positioned and configured without altering the relative orientation of the receivers 302A-H and the transmitters 304A-H. In certain implementations, the receivers 302A-H may be mounted such that the receivers 302A-H are separated from the transmitters 304A-H (e.g., so that the receivers 302A-H can avoid interference from the transmitters 304A-H). For example, the receivers 302A-H may be mounted on structural members 308A-D (only a subset of which are depicted in FIG. 3B) that separate the receivers 302A-H from the transmitters 304A-H. In certain implementations, the transmitter/receiver array 300 may be mounted on a support element, such as the support element 310. The support element 310 may raise the transmitter/receiver array 300 from the ground such that the transmitter/receiver array 300 is at a height better suited to receiving and transmitting audio transmission 200 (e.g., at or between chest and waist height for a typical individual). Additionally or alternatively, the transmitter/receiver array 300 may be mounted on a table, counter, or ceiling (e.g., in a retail establishment).

It should be appreciated that additional or alternative implementations of the transmitter/receiver array 300 are possible. For example, alternative implementations may have more or fewer transmitters and/or receivers and/or may have larger or smaller transmitters and/or receivers. As another example, alternative implementations may omit one or more of the support body 306, the structural members 308A-D, and/or the support elements 310. As yet another example, alternative implementations may further include a housing surrounding the transmitters 304A-H and/or receivers 302A-H.

The transmitter/receiver array 300 may be an exemplary implementation of a merchant device. For example, the transmitter/receiver array 300 may be implemented as part of a point-of-sale (“POS”) device. A computing device 402 (e.g., a customer's mobile device) may transmit audio transmissions to the merchant device and may receive audio transmissions 406 from the merchant device.

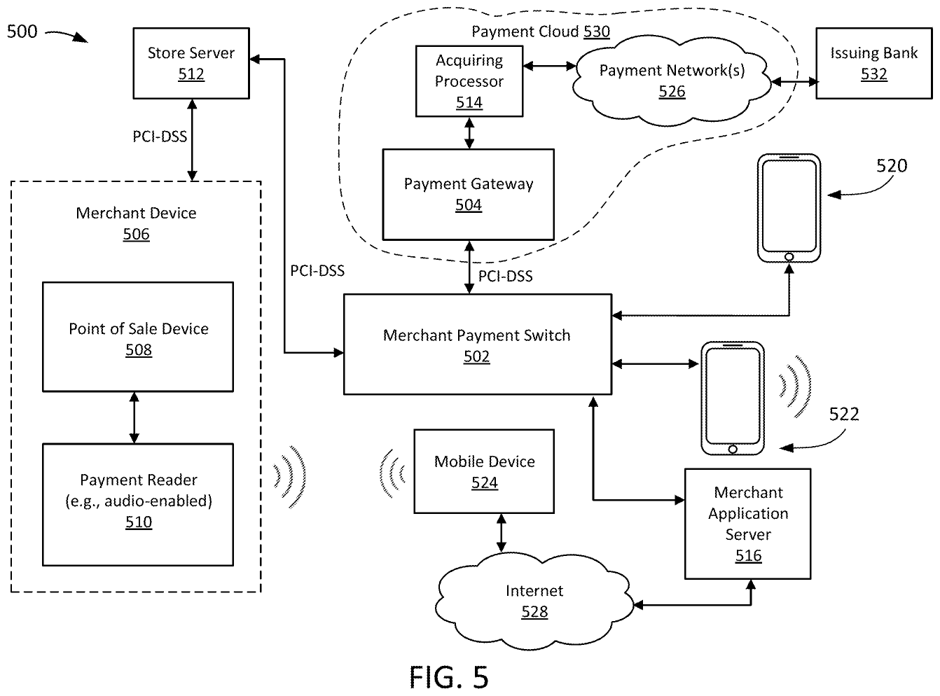

For example, FIG. 5 illustrates a scenario 500 in which mobile devices 520, 522 and 524 communicate with a merchant device 506 and server merchant payment switch 502. In the illustrated scenario, mobile device 524 may communicate with the merchant payment switch 502 through a merchant application server 516 over the internet 528. The merchant payment switch 502 may communicate with a payment cloud 530 comprising a payment gateway 504, an acquiring processor 514 and a payment network(s) 526. The merchant device 506 may be a POS device with a payment reader 510 (e.g., an audio-enabled payment reader). For example, the POS device 508 without audio transmission and receiving capabilities may be paired with or coupled to an audio-enabled payment reader 510 capable of transmitting and receiving audio transmissions with transaction data. The merchant device 506 may run a software development kit (SDK) that provides the audio-enabled payment capabilities. Additionally, the merchant device 506 or more specifically the merchant's or store's POS device 508 may communicate with a merchant server or store server 512, which in-turn communicates with the merchant payment switch 502. The mobile device 524 may transmit audio transmission to the payment reader 510 and may receive audio transmissions from the payment reader 510 of the merchant device 506.

Information from the audio transmissions may also be passed to the merchant's payment gateway or merchant payment switch 502 to be processed. For example, card details and/or tokens associated with a card may be sent to the payment gateway or merchant payment switch 502, which communicates with a payment gateway 504. The payment gateway(s) 504 may include payment processing services such as Stripe®, Paypal®, Cybersource®, etc. The payment gateway 504 may be part of a payment cloud 530 that also includes an acquiring processor 514 and various payment network(s) 526, such as Visa®, MasterCard®, Amex®, etc. The acquiring processor 514 associated with a specific transaction may be nominated by a financial institution associated with the payment gateway 504. Additionally, the payment cloud 530 may communicate with an issuing bank 532. The merchant payment switch 502 may communicate with the issuing bank 532 through the payment cloud 530 to review and verify the information and either approve or decline the transaction. As illustrated in FIG. 5, communications may be handled according to the Communication between the merchant device 506 and the store server 512 may be Payment Card Industry Data Security Standard (PCI-DSS), which is an information security standard that increases controls around data (e.g., cardholder data) to reduce fraud (e.g., credit card fraud).

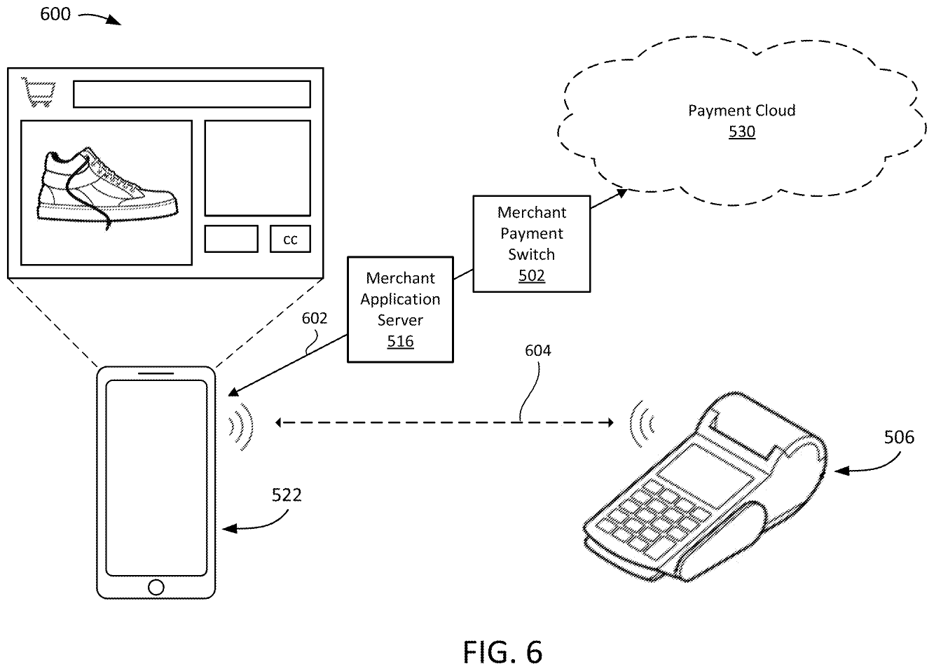

FIG. 6 illustrates a scenario 600 in which mobile device 522 communicates with a merchant device 506 and a payment network or payment cloud 530. In the illustrated example, the mobile device 522 receives an audio transmission via a first communication interface 604. The first communication interface 604 may be an audio interface where both the mobile device 522 and merchant device 506 include transmitters or transducers capable of generating audio signals, such as speakers or ultrasonic transducers. Additionally, both the mobile device 522 and merchant device 506 may include receivers capable of receiving audio transmissions and converting the audio transmissions into signals, such as microphones. In an example, audio transmissions via the first communication interface 604 occur in an ultrasonic frequency range (e.g., a frequency above 20 kHz).

The audio transmission may contain purchase information for a transaction transmitted from the merchant device 506. Then, the mobile device 522 displays the purchase information. For example, the mobile device 522 may receive the purchase information and display a picture of a product, such as a shoe, and other product information (e.g., product cost, product size, product color, etc.) along with a quantity. A customer may approve the transaction on the mobile device 522. For example, the mobile device 522 may display an approval icon such as a “pay now” or “buy” button on the display. After the customer approves the transaction, the mobile device 522 may execute the transaction via a second communication interface 602.

The mobile device 522 may communicate with the merchant application server 516, the merchant payment switch 502 and ultimately to the payment cloud 530 through a second communication interface, which may be a network communication interface such as a wireless network interface. The network communication interface may be an interface for a Wi-Fi network, a wireless PAN (WPAN) (such as, for example, a Bluetooth® WPAN), a WI-MAX network, a cellular data network, or any other suitable wireless network or a combination of two or more of these. In an example, data may be transmitted over the internet to the merchant application server 516, merchant payment switch 502 and/or the payment cloud 530 for processing and validation. The mobile device 522 may execute the transaction through a payment application on the mobile device 522. For example, the transaction may be executed by sending details to the payment cloud 530 and/or merchant device 506 such as the card details (e.g., credit card number, expiration date, CVV, billing zip code) for validation.

In an example, the mobile device 522 may send other information other than a user's or customer's actual card numbers. Instead, the mobile device 522 may facilitate a payment card tokenization process in which a token stands for a customer's actual credit or debit card number. For example, a customer may add a credit or debit card to a payment application on the mobile device 522. When adding a card, the customer may verify their identity. After the customer's identity is verified, the mobile device 522 may request a token to represent the card that has been issued to the mobile device's payment application. Once the token is issued, the customer's card may be “tokenized”, which may further be encrypted before the card is used for payments. The mobile device 522 may securely store multiple customer tokens associated with various payment types (e.g., different credit or debit cards), various payment platforms, and/or various merchants. The mobile device 522 may then transmit tokens to the payment network or payment cloud 530 during a transaction. For example, the customer's payment application may execute the transaction by responding to a purchase request with the customer's tokenized card and a key, secret or cryptogram that serves as a single use password. Then, the payment cloud 530 may validate the single use password and may match the token with the customer's actual card number.

Tokenizing cards may include a gateway token for a card-not-present transaction or a network token for a card-present transaction. The tokenization process may be performed at the payment gateway(s) 504, at the acquiring processor 514, or through some other token service provider. With a gateway token for a card-not-present transaction, the payment gateway(s) 504 tokenize card info and store the token (e.g., “T1”) in a payment gateway vault or a token vault. The payment gateway vault or token vault allows merchants to store credit card information on file for users. The payment gateway(s) 504 also provide a pointer ID (e.g., “T1P_ID”) mapped back to the merchant payment gateway that is connected to the merchant application server 516. The user account on the device (e.g., mobile device 524) and the financial instrument (e.g., credit card) stored in the wallet are paired to reference or associate this unique reference ID (e.g., “T1P_ID”) with the financial instrument (e.g., credit card). The merchant application server 516 has record of a unique user ID (e.g., “UA_ID”) and a mobile device ID (e.g., “UA-M1_ID”). The merchant application server 516 may generate a reference ID pointing to the tokenized ID (e.g., “RFI1_ID”), which may be considered a reference funding instrument ID. In the example of a gateway token, the gateway token is stored in the payment gateway vault and only a reference to the token may be handed to the merchant payment switch 502 by the payment gateway 504. Additionally, the merchant application server 516 creates a unique software based pointer to the referenced gateway token.

With a network token, which may be used for a card-present transaction, device based tokens or cloud based tokens may be used. The network tokens essentially serve as an alias for a payment card number, primary account number (PAN), or card number that is exchanged during an authorization by the payment network. A device based token may be secured via biometrics on a mobile device 524 (e.g., an iOS device) while cloud based tokens may be used with hosted card emulation systems (e.g., Android Hosted Card Emulation). For example, the tokens may be provisioned into the secure elements on the mobile device or on cloud servers. Hosted card emulation (“HCE”) enables a smartcard to be mimicked on a mobile device 524 using software, such that transaction data and card credentials are stored in a cloud server, rather than inside the mobile device 524. In another example, an EMV® token that is provisioned between an issuer, a wallet and a token service provider may be used. Tokenizing cards or other financial instruments may be achieved according to the EMV® payment specification and/or the ISO/IEC 7816 standards.

A consumer device, such as mobile device 524, may perform another card verification method that utilizes sound as a “user-present” or “device-present” proximity indicator. For example, purchase information and payment transaction confirmations may be transmitted as secure audio transmissions. As previously mentioned, audio transmissions may provide additional security due to the proximity required between the transmitting and receiving devices, while also enabling users to perform such transactions without having to be next to merchant devices, as may be required for NFC or similar protocols. For example, sound information may be wirelessly transmitted via audio transmissions without specialized hardware (e.g., using existing speakers and microphones on the devices) and without communicatively pairing the devices prior to the transaction. The audio transmissions may convey token information, unique identifiers, and other identifiers described above based on the tokenization method. The consumer device (e.g., mobile device 524) and card verification method using audio transmissions may be performed in a similar fashion as the token examples above, where the information provided between the user and the merchant is through audio transmissions.

Depending on the type or nature of the token (e.g., gateway token, network token, EMV token, etc.), the payment gateway 504 or payment network(s) 526 may route the token to the appropriate network participants. As discussed above, tokenization may be handled by the payment gateway 504, the payment network(s) 524, or through another token service provider. Tokens may be single-pay tokens or multi-pay tokens. A multi-pay token may be used for card-not-present transactions or for repeat customers, where the card information is stored in a mobile wallet or on a website. In some examples, tokenization may occur before data is passed to the payment gateway 504, acquiring processor(s) 514 or payment network(s) 526. In other examples, the merchant may utilize a tokenization service provided by the processor (e.g., acquiring processor 514), which may typically require cardholder data to be encrypted before being passed to the processor. After the processor (e.g., acquiring processor 514) accepts, decrypts and tokenizes the encrypted data, the card is processed for authorization and the authorization response is paired with the token, which is then sent back to the merchant. The tokens may be utilized for repeat purchases, recurring payments, chargebacks, and refunds.

Specifically, referring back to FIG. 5, the payment cloud 530 may communicate with a merchant payment switch 502, a payment gateway 504 and various other acquiring processors and issuing banks (e.g., merchant's acquiring bank and the customer's card issuing bank), and a card network to review the information and either approve or decline the transaction. For example, the merchant's acquiring bank and the customer's card issuing bank may use existing customer information and decrypted customer billing information to complete the transaction. If the transaction is approved by the payment network (e.g., card is accepted instead of declined), the payment cloud 530 sends a confirmation to the mobile device 522 via the second communication interface or over the internet. After receiving the confirmation from the payment cloud 530, the mobile device 522 sends an audio transmission containing the confirmation to the merchant device 506 via the first communication interface 604.

As discussed above, and referring back to FIG. 2, the audio transmission may include a preamble 202 and a payload 204 (e.g., the confirmation). The payload may include packet(s) 208 containing confirmation data and a header 206 that includes additional information relevant to processing the data contained within the packet(s) 208. For example, the header 206 may include routing information for a final destination of the confirmation data or the header 206 may indicate an originating source of the data (e.g., an identifier of the customer or mobile device 522).

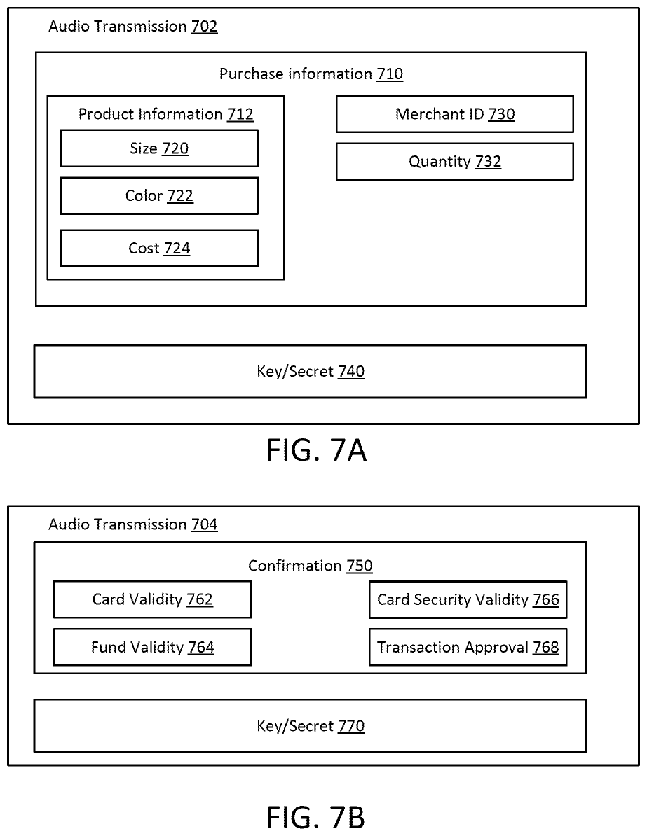

FIGS. 7A and 7B illustrate example audio transmissions 702, 704. Audio transmission 702 may include purchase information 710, which may comprise product information 712, merchant information such as a merchant ID 730 and a quantity 732. The merchant information may include an identifier associated with a retail POS device, a retail employee device, a drive thru POS device, etc. The product information 712 may include information about the size 720, color 722, and cost 714 of the product. Additionally or alternatively, the product information 712 may include a unique identifier of a product to be purchased, such as a universal product code (UPC) for the product. In still further implementations, the purchase information 710 may include a transaction identifier for the transaction that is to be processed. For example, a user and/or retail employee may queue up a transaction for payment using a mobile device and the transaction may be associated with a unique identifier. In addition to the merchant information being associated with identifiers, the shopper or user's mobile device may also be associated with an identifier or other descriptive information. For example, the shopper or user's mobile device may be identified along with information on whether the device is performing a purchase in-store or out-of-store. In some examples, the user device may be an automobile or other device associated with a user's vehicle when making a purchase in a drive thru setting. The purchase information 710 may be generated to include the unique identifier for subsequent use in processing the payment (e.g., for use in processing the payment with a payment network). In certain implementations, the unique identifier may be included in addition to or alternatively to the product information 712. The audio transmission 702 may also include a security key/secret 740 associated with the audio transmission 702 to further enhance the security of the transmission. The audio transmissions 702 and 704 may be associated with a retail POS device and a user's mobile device, a retail employee device and a user's mobile device whether in-store or out-of-store, a drive thru POS device and a user's mobile device or automobile, or any combination thereof.

Audio transmission 704 may include a transaction confirmation 750 a security key/secret 770 associated with the audio transmission 704 to further enhance the security of the transmission. The confirmation 750 may include information regarding card validity 762, fund validity 764 indicating that sufficient funds are available, card security validity 766 and a transaction approval 768.

In an example, a merchant device 506 sends the audio transmission 702 with purchase information 710 to a user's mobile device (e.g., mobile device 522 of FIG. 6). Then, the user approves the transaction and executes the transaction over or through a payment switch (e.g., merchant payment switch 502 of FIG. 5) or a payment cloud (e.g., payment cloud 530 of FIG. 5 and FIG. 6). In one example, to execute the transaction, the customer's card details are sent to a payment gateway 504 and then to the merchant's acquiring bank, acquiring processor 514 or an associated third party processor via an internet connection (e.g., communication interface 602 of FIG. 6). Then, the payment gateway 504 forwards the credit card details to a payment network 526, such as a credit card network, which clears the payment and requests payment authorization from the customer's issuing bank (e.g., issuing bank 532 of FIG. 5). The authorization request may include a card number, card expiration date, customer information such as a billing address for use by an address verification system (“AVS”) validation, a card security code (e.g., a card verification value (CVV)), and a payment amount.

Then, the transaction may be authenticated. For example, the customer's issuing bank 532 may receive a payment authorization request from the payment network 526 (e.g., credit card network). Then, the customer's issuing bank 532 verifies the validity of the customer's credit card and provides card validity information 762. In an example, the customer's issuing bank 532 verifies card validity using a fraud protection tools such as AVS. The customer's issuing bank 532 may also verify card security and provide card security validity information 766. For example, the customer's issuing bank 532 may verify card security codes using protocols such as CVV, CVV2, CVC2 and CID. Additionally, the customer's issuing bank 532 may also check the amount of available funds and provide fund validity information 764. Then, the customer's issuing bank 532 approves, or declines, the transaction (indicated by transaction approval information 768) and sends back the appropriate confirmation 750.

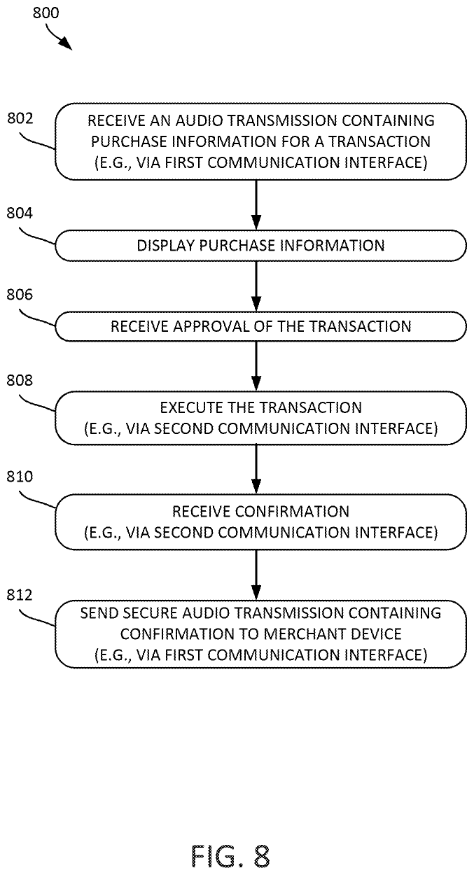

FIG. 8 illustrates a method 800 according to an exemplary embodiment of the present disclosure. The method 800 may be implemented on a computer system, such as the computing device(s) 102, 104, 402 or mobile devices 520, 522, 524. The method 800 may also be implemented by a set of instructions stored on a computer readable medium that, when executed by a processor, cause the computer system to perform the method 800. For example, all or part of the method 800 may be implemented by a processor and a memory of the computing device(s) 102, 104, 402 or mobile devices 520, 522, 524. Although the examples below are described with reference to the flowchart illustrated in FIG. 8, many other methods of performing the acts associated with FIG. 8 may be used. For example, the order of some of the blocks may be changed, certain blocks may be combined with other blocks, one or more of the blocks may be repeated, and some of the blocks described may be optional.

The method 800 begins with receiving an audio transmission containing purchase information for a transaction (block 802). For example, the computing device 102, 104, 402 or mobile device 520, 522, 524 (hereinafter referred to generally as mobile device 522) may receive an audio transmission 702 from a merchant device 506 via a first communication interface 604. The audio transmission 702 may include purchase information 710 for the transaction. The purchase information may additionally include other information identifying or describing the transaction such as a merchant identification information (e.g., merchant ID 730), quantity information 732, etc. The product information 712 may include size 720, color 722 and cost 724 information among other information identifying and describing the product, service, and/or transaction for which a payment is being processed. The first communication interface 604 may be an audio interface where both the mobile device 522 and merchant device 506 include transmitters capable of generating audio signals, such as speakers and receivers capable of receiving audio transmissions and converting the audio transmissions into signals, such as microphones. In an example, the audio transmission 702 via the first communication interface 604 occurs in an ultrasonic frequency range (e.g., a frequency above 20 kHz).

Purchase information may be displayed by mobile device (block 804). For example, the mobile device 522 may display purchase information such as a picture of a product, such as a shoe, and other product information (e.g., product cost, product size, product color, etc.) along with a quantity. The purchase information 710 may be dependent on the product or service associated with the transaction. Additionally, the purchase information 710 may depend on and may be formatted based on the merchant or merchant device 506 supplying the purchase information 710. In certain implementations, all of the displayed purchase information may be received via an audio transmission 702. In additional or alternative implementations, the displayed purchase information 710 may be retrieved (e.g., from a merchant server) based on information contained within the audio transmission 702 (e.g., based on a unique identifier of a product and/or transaction for which payment is being processed.

Then, approval of the transaction is received (block 806). For example, the mobile device 522 receives approval of the transaction from a user (e.g., a customer). The user may approve the transaction using a selection button or icon. For example, the mobile device 522 may display an approval icon such as a “pay now” or “buy” button on the device's display. Afterwards, the transaction is executed (block 808). After receiving approval of the transaction from the user, the mobile device 522 executes the transaction via a second communication interface 602. The second communication interface 602 may be a network communication interface such as a wireless network interface or the internet.

The mobile device also receives a confirmation (block 810). For example, the mobile device 522 receives a confirmation 750 via the second communication interface 602. The confirmation may be provided after the transaction is verified and validated by the merchant's acquiring bank or processor, customer's issuing bank 532, and the payment network (e.g., credit card network). For example, the customer's issuing bank 532 may verify the validity of the customer's credit card, verify card security, and verify the customer has sufficient funds etc. before confirming that the transaction is approved.

Next, the mobile device sends an audio transmission containing the confirmation to the merchant device (block 812). For example, the mobile device 522 sends an audio transmission 704 containing the confirmation 750 to the merchant device 506. The audio transmission 704 may be sent over the first communication interface 604 (e.g., an audio interface). By communicating purchase information 710 and a transaction confirmation 750 via an audio interface, customer mobile devices 522 and merchant devices 506 are capable of communicating and exchanging data without connecting to the same communication network. For example, computing devices (e.g., customer mobile devices 522 and merchant devices 506) typically have to be communicatively paired in order to transmit data according to specific wireless communication protocols. As previously discussed, such communicative pairing may be cumbersome and slow. Instead of communicatively pairing merchant device 506 and mobile device 522, method 800 describes wirelessly transmitting information using audio transmissions such that neither the merchant device 506 nor the mobile device 522 requires specialized hardware or requires communicative pairing prior to data transmission.

In an example, a user may present card data to a merchant device 506, such as a POS device 508. Alternatively, a user may present card data while performing an online transaction (e.g., online shopping). The encrypted card data may then be transmitted to an acquirer (e.g., acquiring processor 514) via a merchant payment switch 502 and a payment gateway 504. As discussed above, the acquiring processor 514 may submit the encrypted card data for tokenization via a token service provider. The acquiring processor 514 then routes an authorization request to a payment network(s) 526, such as Visa®, MasterCard®, Amex®, etc. depending on the type of card presented. The authorization request includes the encrypted card data, and the authorization request is routed to an issuer (e.g., issuing bank 532). The issuer or issuing bank 532 receives the request and sends an authorization response back to the acquirer. After the authorization response is received from the payment network(s) 526, the authorization response and associated token are received by the merchant system to complete the transaction.

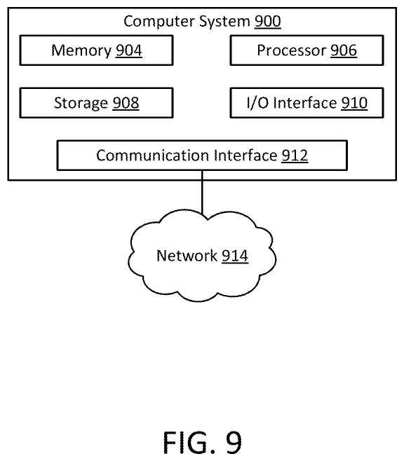

FIG. 9 illustrates an example computer system 900 that may be utilized to implement one or more of the devices and/or components of FIGS. 1, 5 and 6, such as the computing devices 102, 104 and mobile devices 520, 522 and 524. In particular embodiments, one or more computer systems 900 perform one or more steps of one or more methods described or illustrated herein. In particular embodiments, one or more computer systems 900 provide the functionalities described or illustrated herein. In particular embodiments, software running on one or more computer systems 900 performs one or more steps of one or more methods described or illustrated herein or provides the functionalities described or illustrated herein. Particular embodiments include one or more portions of one or more computer systems 900. Herein, a reference to a computer system may encompass a computing device, and vice versa, where appropriate. Moreover, a reference to a computer system may encompass one or more computer systems, where appropriate.

This disclosure contemplates any suitable number of computer systems 900. This disclosure contemplates the computer system 900 taking any suitable physical form. As example and not by way of limitation, the computer system 900 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, the computer system 900 may include one or more computer systems 900; be unitary or distributed; span multiple locations; span multiple machines; span multiple data centers; or reside in a cloud, which may include one or more cloud components in one or more networks. Where appropriate, one or more computer systems 900 may perform without substantial spatial or temporal limitation one or more steps of one or more methods described or illustrated herein. As an example and not by way of limitation, one or more computer systems 900 may perform in real time or in batch mode one or more steps of one or more methods described or illustrated herein. One or more computer systems 900 may perform at different times or at different locations one or more steps of one or more methods described or illustrated herein, where appropriate.

In particular embodiments, computer system 900 includes a processor 906, memory 904, storage 908, an input/output (I/O) interface 910, and a communication interface 912. Although this disclosure describes and illustrates a particular computer system having a particular number of particular components in a particular arrangement, this disclosure contemplates any suitable computer system having any suitable number of any suitable components in any suitable arrangement.

In particular embodiments, the processor 906 includes hardware for executing instructions, such as those making up a computer program. As an example and not by way of limitation, to execute instructions, the processor 906 may retrieve (or fetch) the instructions from an internal register, an internal cache, memory 904, or storage 908; decode and execute the instructions; and then write one or more results to an internal register, internal cache, memory 904, or storage 908. In particular embodiments, the processor 906 may include one or more internal caches for data, instructions, or addresses. This disclosure contemplates the processor 906 including any suitable number of any suitable internal caches, where appropriate. As an example and not by way of limitation, the processor 906 may include one or more instruction caches, one or more data caches, and one or more translation lookaside buffers (TLBs). Instructions in the instruction caches may be copies of instructions in memory 904 or storage 908, and the instruction caches may speed up retrieval of those instructions by the processor 906. Data in the data caches may be copies of data in memory 904 or storage 908 that are to be operated on by computer instructions; the results of previous instructions executed by the processor 906 that are accessible to subsequent instructions or for writing to memory 904 or storage 908; or any other suitable data. The data caches may speed up read or write operations by the processor 906. The TLBs may speed up virtual-address translation for the processor 906. In particular embodiments, processor 906 may include one or more internal registers for data, instructions, or addresses. This disclosure contemplates the processor 906 including any suitable number of any suitable internal registers, where appropriate. Where appropriate, the processor 906 may include one or more arithmetic logic units (ALUs), be a multi-core processor, or include one or more processors 906. Although this disclosure describes and illustrates a particular processor, this disclosure contemplates any suitable processor.

In particular embodiments, the memory 904 includes main memory for storing instructions for the processor 906 to execute or data for processor 906 to operate on. As an example, and not by way of limitation, computer system 900 may load instructions from storage 908 or another source (such as another computer system 900) to the memory 904. The processor 906 may then load the instructions from the memory 904 to an internal register or internal cache. To execute the instructions, the processor 906 may retrieve the instructions from the internal register or internal cache and decode them. During or after execution of the instructions, the processor 906 may write one or more results (which may be intermediate or final results) to the internal register or internal cache. The processor 906 may then write one or more of those results to the memory 904. In particular embodiments, the processor 906 executes only instructions in one or more internal registers or internal caches or in memory 904 (as opposed to storage 908 or elsewhere) and operates only on data in one or more internal registers or internal caches or in memory 904 (as opposed to storage 908 or elsewhere). One or more memory buses (which may each include an address bus and a data bus) may couple the processor 906 to the memory 904. The bus may include one or more memory buses, as described in further detail below. In particular embodiments, one or more memory management units (MMUs) reside between the processor 906 and memory 904 and facilitate accesses to the memory 904 requested by the processor 906. In particular embodiments, the memory 904 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 904 may include one or more memories 904, where appropriate. Although this disclosure describes and illustrates particular memory implementations, this disclosure contemplates any suitable memory implementation.

In particular embodiments, the storage 908 includes mass storage for data or instructions. As an example and not by way of limitation, the storage 908 may include a hard disk drive (HDD), a floppy disk drive, flash memory, an optical disc, a magneto-optical disc, magnetic tape, or a Universal Serial Bus (USB) drive or a combination of two or more of these. The storage 908 may include removable or non-removable (or fixed) media, where appropriate. The storage 908 may be internal or external to computer system 900, where appropriate. In particular embodiments, the storage 908 is non-volatile, solid-state memory. In particular embodiments, the storage 908 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 908 taking any suitable physical form. The storage 908 may include one or more storage control units facilitating communication between processor 906 and storage 908, where appropriate. Where appropriate, the storage 908 may include one or more storages 908. Although this disclosure describes and illustrates particular storage, this disclosure contemplates any suitable storage.

In particular embodiments, the I/O Interface 910 includes hardware, software, or both, providing one or more interfaces for communication between computer system 900 and one or more I/O devices. The computer system 900 may include one or more of these I/O devices, where appropriate. One or more of these I/O devices may enable communication between a person (i.e., a user) and computer system 900. As an example and not by way of limitation, an I/O device may include a keyboard, keypad, microphone, monitor, screen, display panel, mouse, printer, scanner, speaker, still camera, stylus, tablet, touch screen, trackball, video camera, another suitable I/O device or a combination of two or more of these. An I/O device may include one or more sensors. Where appropriate, the I/O Interface 910 may include one or more device or software drivers enabling processor 906 to drive one or more of these I/O devices. The I/O interface 910 may include one or more I/O interfaces 910, where appropriate. Although this disclosure describes and illustrates a particular I/O interface, this disclosure contemplates any suitable I/O interface or combination of I/O interfaces.

In particular embodiments, communication interface 912 includes hardware, software, or both providing one or more interfaces for communication (such as, for example, packet-based communication) between computer system 900 and one or more other computer systems 900 or one or more networks 914. As an example and not by way of limitation, communication interface 912 may include a network interface controller (NIC) or network adapter for communicating with an Ethernet or any other wire-based network or a wireless NIC (WNIC) or wireless adapter for communicating with a wireless network, such as a Wi-Fi network. This disclosure contemplates any suitable network 914 and any suitable communication interface 912 for the network 914. As an example and not by way of limitation, the network 914 may include one or more of an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 900 may communicate with a wireless PAN (WPAN) (such as, for example, a Bluetooth® WPAN), a WI-FI network, a WI-MAX network, a cellular telephone network (such as, for example, a Global System for Mobile Communications (GSM) network), or any other suitable wireless network or a combination of two or more of these. Computer system 900 may include any suitable communication interface 912 for any of these networks, where appropriate. Communication interface 912 may include one or more communication interfaces 912, where appropriate. Although this disclosure describes and illustrates a particular communication interface implementations, this disclosure contemplates any suitable communication interface implementation.

The computer system 902 may also include a bus. The bus may include hardware, software, or both and may communicatively couple the components of the computer system 900 to each other. As an example and not by way of limitation, the bus may include an Accelerated Graphics Port (AGP) or any other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local bus (VLB), or another suitable bus or a combination of two or more of these buses. The bus may include one or more buses, where appropriate. Although this disclosure describes and illustrates a particular bus, this disclosure contemplates any suitable bus or interconnect.

Herein, a computer-readable non-transitory storage medium or media may include one or more semiconductor-based or other types of integrated circuits (ICs) (e.g., field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A system comprising:
a processor; and
a memory storing instructions which, when executed by the processor, cause the processor to:
receive, via a first communication interface, a first audio transmission containing purchase information for a transaction transmitted from a merchant device,
display the purchase information,
receive approval of the transaction from a user,
responsive to receiving approval of the transaction from a user, execute, via a second communication interface, the transaction,
receive a confirmation via the second communication interface, and
send, via the first communication interface, an audio transmission containing the confirmation to the merchant device.

2. The system of claim 1, wherein the processor is further caused to locate the merchant device.

3. The system of claim 1, wherein the merchant device is a point of sale (POS) device.

4. The system of claim 1, wherein the purchase information includes at least one of a product identifier, a transaction identifier, a merchant identifier, and cost information.

5. The system of claim 1, wherein the confirmation includes at least one of card validity information and card security information.

6. The system of claim 1, wherein the confirmation includes at least one fund availability information and transaction approval information.

7. The system of claim 1, wherein a mobile device includes the processor, and the mobile device is one of a mobile phone, a personal digital assistant (PDA), and a tablet.

8. The system of claim 1, wherein at least one of the first and second audio transmissions occur in an ultrasonic frequency range.

9. The system of claim 8, wherein the mobile device includes an ultrasonic transducer and an ultrasonic receiver, the ultrasonic transducer is configured to transmit digital data at frequencies above 20 kHz.

10. The system of claim 8, wherein the merchant device includes an ultrasonic transducer and an ultrasonic receiver, the ultrasonic transducer is configured to transmit digital data at frequencies above 20 kHz.

11. The system of claim 1, wherein the transaction is a card-not-present transaction.

12. A method comprising:
receiving, by a mobile device, via a first communication interface, a first audio transmission containing purchase information for a transaction transmitted from a merchant device;
displaying, by the mobile device, the purchase information;
receiving, by the mobile device, approval of the transaction from a user;
responsive to receiving approval of the transaction from the user, executing, by the mobile device, the transaction via a second communication interface;
receiving, by the mobile device, a confirmation via the second communication interface; and
sending, by the mobile device, an audio transmission containing the confirmation, via the first communication interface, to the merchant device.

13. The method of claim 12, further comprising:
locating, by the mobile device, the merchant device.

14. The method of claim 12, wherein the merchant device is a point of sale (POS) device.

15. The method of claim 12, further comprising:
reviewing, by a user on the mobile device, the purchase information.

16. The method of claim 12, wherein the purchase information includes at least one of a product identifier, a transaction identifier, a merchant identifier, and cost information.

17. The method of claim 12, wherein the confirmation includes at least one of card validity information, card security information, fund availability information, and transaction approval information.

18. The method of claim 12, wherein at least one of the first and second audio transmissions occur in an ultrasonic frequency range.

19. The method of claim 18, wherein at least one of the mobile device and the merchant device includes an ultrasonic transducer and an ultrasonic receiver, the ultrasonic transducer configured to transmit digital data at frequencies above 20 kHz.

20. The method of claim 12, wherein the transaction is a card-not-present transaction.
